(19) United States
(12) Patent Application Publication
(10) Pub. No.: US 2015/0347365 A1
(43) Pub. Date: Dec. 3, 2015

(54) SYSTEM AND METHOD FOR DISTRIBUTING CENSORED AND ENCRYPTED VERSIONS OF A DOCUMENT

(71) Applicant: Clault Pte. Ltd., Singapore (SG)

(72) Inventors: Qiming Li, Singapore (SG); Kee Woon Tan, Singapore (SG)

(21) Appl. No.: 14/730,133

(22) Filed: Jun. 3, 2015

Related U.S. Application Data
(60) Provisional application No. 62/007,107, filed on Jun. 3, 2014.

(51) Int. Cl. G06F 17/24; G06F 3/041; G06F 21/62; G06F 3/0484

(52) U.S. Cl. CPC G06F 17/24; G06F 3/04842; G06F 3/0412; G06F 21/6209

(57) ABSTRACT

A portion of a document is altered in response to a user selection input to protect that portion. As a result, an original content provided in the selected portion of the document is not viewable, while original content in other portions of the document are viewable. A copy of the document with the portion unaltered is stored in encrypted form. One or more recipients that are permitted to view the document in its entirety are identified. The copy of the document with the portion unaltered is provided to the one or more recipients.

### RELATED APPLICATIONS

This application claims the benefit of priority to Provisional U.S. Patent Application No. 62/007,107, entitled, “System And Method For Distributing Censored And Encrypted Versions Of A Document,” filed Jun. 3, 2014; the aforementioned priority application being hereby incorporated by reference in its entirety.

### TECHNICAL FIELD

Examples described herein pertain to a system and method for distributing censored and encrypted versions of a document.

### BRIEF DESCRIPTION OF THE DRAWINGS

FIG. 1 illustrates a system for enabling selective sharing of censored documents, according to one or more embodiments.

FIG. 2 implements a method for enabling selective sharing of censored documents, according to one or more embodiments.

FIG. 3 illustrates a method for operating a recipient device to access a protected document, according to one or more embodiments.

FIG. 4 illustrates an example implementation of a censored document, according to one or more embodiments.

FIG. 5 is a block that illustrates a computer system upon which embodiments described herein may be implemented.

### DETAILED DESCRIPTION

Examples provided herein include a system and method for securely sharing information. In particular, examples described herein provide for a system and method that enables documents to include selective portions that are censored from a population of viewers, while a separate copy of the document is encrypted in its original form. Among other benefits, examples described herein enable a censored copy of a document to be permanently altered to selectively censor content, thereby enabling the document to be disseminated to a population of users without disclosure of the censored content. At the same time, an unaltered version of the document can be encrypted and disseminated to recipients (other than the document creator) who are individually authorized to receive the document.

In one embodiment, a portion of a document is altered in response to a user selection input to protect that portion. As a result, an original content provided in the selected portion of the document is not viewable, while original content in other portions of the document are viewable. A copy of the document with the portion unaltered is stored in encrypted form. One or more recipients that are permitted to view the document in its entirety are identified. The copy of the document with the portion unaltered is provided to the one or more recipients.

One or more embodiments described herein provide that methods, techniques and actions performed by a computing device are performed programmatically, or as a computer-implemented method. Programmatically means through the use of code, or computer-executable instructions. A programmatically performed step may or may not be automatic.

One or more embodiments described herein may be implemented using programmatic modules or components. A programmatic module or component may include a program, a subroutine, a portion of a program, or software or a hardware component capable of performing one or more stated tasks or functions. As used herein, a module or component can exist on a hardware component independently of other modules or components. Alternatively, a module or component can be a shared element or process of other modules, programs or machines.

Furthermore, one or more embodiments described herein may be implemented through instructions that are executable by one or more processors. These instructions may be carried on a computer-readable medium. Machines shown or described with figures below provide examples of processing resources and computer-readable mediums on which instructions for implementing embodiments of the invention can be carried and/or executed. In particular, the numerous machines shown with embodiments of the invention include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash or solid state memory (such as carried on many cell phones and consumer electronic devices) and magnetic memory. Computers, terminals, network enabled devices (e.g., mobile devices such as cell phones) are all examples of machines and devices that utilize processors, memory, and instructions stored on computer-readable mediums. Additionally, embodiments may be implemented in the form of computer programs, or a computer usable carrier medium capable of carrying such a program.

System Description

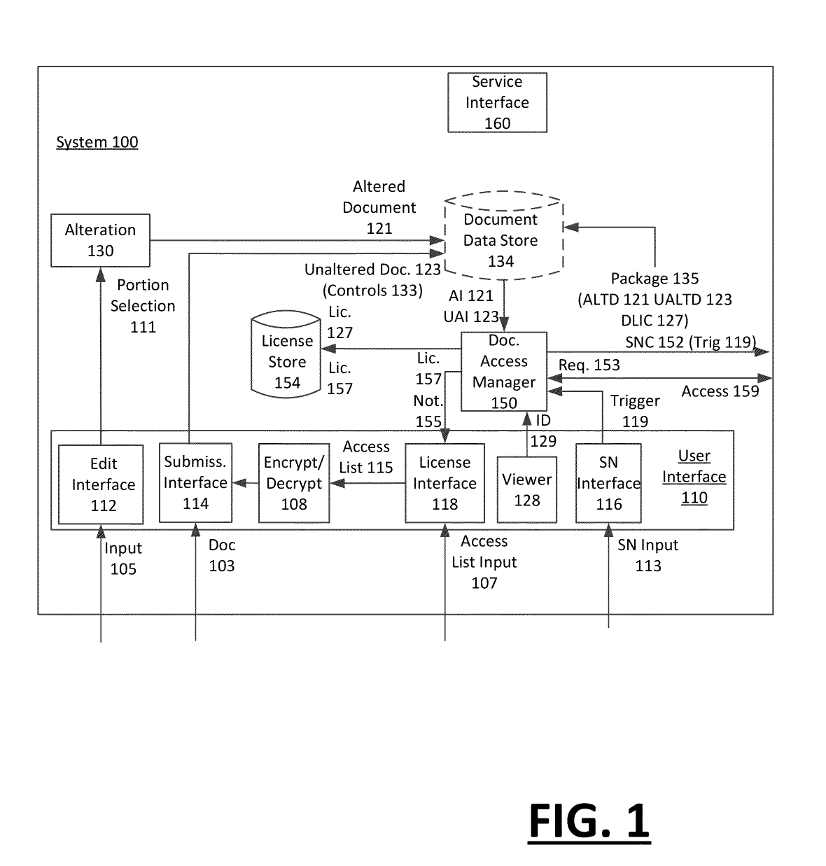

FIG. 1 illustrates a system for enabling selective sharing of censored documents, according to one or more embodiments. A system such as shown by FIG. 1 can be implemented in a variety of computing environments, including as a service implemented by one or more servers, as a client application, and/or as a shared computing environment distributed between client and server. By way of example, system 100 can be implemented as a computing system that executes a web-based application in order to communicate with the network service, for purpose of implementing or performing some or all of the functionality described.

With further reference to FIG. 1, system 100 includes a user interface 110, an alteration component 130, and one or more publication or distribution components for communicating both protected and censored documents to a population of recipients. As described in greater detail, system 100 can operate to enable a user to selectively censor portions of documents, so as to enable distribution of documents which preclude viewing of content originally provided in the censored portions(s). By way of example, a portion of an image can be blurred or otherwise manipulated in order to eliminate information or content, while a remainder of the image remains intact. The image can then be widely distributed in the altered form.

Still further, system 100 can operate to provide unaltered versions of documents for approved recipients. As described in greater detail, an example provides for system 100 to encrypt a copy of an unaltered document. Individuals can be selected to receive a key for unlocking or otherwise viewing the unaltered document. As an addition or alternative, senders or creators of documents can automatically be granted access to view unaltered versions of a document from a public forum such as a social networking site.

In an example of FIG. 1, user interface 110 includes an editing interface 112 and a submission interface 114. The submission interface 114 can provide a mechanism by which the user can submit a document 103 for protection through system 100. For example, user interface 110 can be implemented as part of an application residing on a client terminal. As a variation, user interface 110 can be implemented through a user web browser. The user selection can correspond to unaltered document 123, which can be stored in a protected computing environment, such as provided by a network service.

In one implementation, the user interface 110 also includes an encryption/decryption component 108 and a license interface 118. In the document submission process, the encryption/decryption component 108 can encrypt the unaltered document 123 for storage and access management with system 100. By way of example, the encryption/decryption component 108 can encrypt documents using an AES (Advanced Encryption Standard) and/or RSA algorithm. In one example, the RSA algorithm is used to create a Document Access Licenses for a set of pre-defined recipients. The set of pre-defined recipients can be provided via the license interface 118. The license interface 118 can enable the user to provide input 107 that identifies individuals of an access list 115. In an example of FIG. 1, the access list 115 can correspond to the predefined recipients for which Document Access Licenses are created. The access list 115 can be specific for particular document or set of documents. Individuals identified in the access list 115 for a given document can decrypt the altered document and therefor gain access to the entire content of the unaltered document 123 in its original form.

In one example, edit interface 112 can enable the individual to specify input 105 that identifies a portion of the submitted document 103. The input (“portion selection input 111”) identifies a specific portion of a document that is to be altered so that its original content is indiscernible, or otherwise not viewable. In one implementation, the user interface 110 is provided on a computing device that accepts touch input. In such an implementation, the edit interface 112 can detect user contacting one or more portions of a display screen on which a document is displayed (corresponding to portion selection input 111), and a region that includes the one or more portions can be altered to censor the document of the content appearing in the region.

The alteration component 130 receives portion selection input 111, and then afters a region of the document that includes or otherwise corresponds to the identified portion. The alteration can result in the altered document having a region in which the original content is no longer viewable. In one implementation, the alteration component 130 afters the values of the pixels that comprise the region that is being altered. By way of example, the resulting alteration can be the form of blurring, blackening, or permanently affixing alternative content in place of original content. The alteration component 130 can output an altered document 121 that includes the altered region corresponding to the portion selection input 111.

In the altered document 121, the altered region is isolated, so as to not affect a remainder of the document. Thus, for example, the portion selection input 111 can specify a face in an image, or a paragraph in a PDF document. The altered document 121 can display, in place of the original content (e.g., face or paragraph), blurred pixels, blackened or whitened pixels, or replacement content. For example, a selected face in an image can be blurred, or a selected paragraph can be blackened. As alternative examples, the face depicted in a photograph can be replaced with alternative content (e.g., smiley face). Alternatively, a selected paragraph can be replaced by alternative text content. Numerous such variations are possible as to the manner in which a portion of the document can be altered so that the original content is censored and no longer viewable.

In an example of FIG. 1, a document data store 134 can correspond to one or multiple data stores that collectively retain both the altered document 121 and the unaltered document 123. An example of FIG. 1 provides for the document data store 134 to reside external to system 100. For example, the document data store 134 can correspond to multiple network resources that independently store documents which are then protected and censored using system 100. In variations, the document store 134 can be provided as part of system 100.

In one implementation, the document data store 134 can store the unaltered document 123 in encrypted form. When encrypted, no portion of the unaltered document 123 is viewable to a recipient unless the recipient is in possession of an encryption key. In one implementation, the document data store 134 retains document sets 135 corresponding to individually submitted documents. Each document set 135 can include the unaltered document 123 in encrypted form, the censored or altered document 121, and one or more document access licenses 127 which collectively identify a list of recipients who are permitted to access the unaltered document 123. In a variation, a document license store 154 retains the document licenses 127 for individual documents (which are maintained with the document data store 134) separately from the altered and unaltered documents 121, 123. Thus, the document set 135 can be distributed, with the document licenses 127 retained separately from the altered and unaltered documents 121, 123 respectively.

In a variation, the document set 135 or its components (altered document 121, unaltered document 123, document access license 127) can be stored with an alternative service provider, such as an online storage service (e.g., DROPBOX). In an example of FIG. 1, service interface 160 can interface the documents of a particular user/owner with an online account of a third-party network service provider. In this way, document set 135, including the altered document 121, the unaltered document 123 and the document access licenses 127, can be stored and accessed with the user account at a third-party service.

In an example of FIG. 1, document access manager 150 can interface with the document data store 134 to enable sharing and distribution of the altered document 121 and the unaltered document 123. The document access manager 150 can be implemented as one or more processes. In one implementation, the document access manager 150 enables the user to select an altered document 121 for publication or distribution in one or multiple different environments, such as in a social networking environment.

According to one aspect, the user can provide input 113 via the user interface 110 in order to identify a publication source for the altered document 121. The publication source can correspond to a social networking site, such as provided by FACEBOOK, TWITTER or GOOGLE PLUS. In variations, other publication sources can be utilized, such as messaging transports or shared folders.

In one implementation, a social networking interface 116 can be provided to enable the user to distribute the altered document in a social networking environment specified by the input 113 (e.g., as a post in a user's given social networking account). In particular, the social networking interface 116 can provide a trigger 119 or other programmatic elements to cause the document access manager 150 to output social networking content 152 that includes or corresponds to the altered document 121. The social network output 152 can include additional information and content, such as messages informing viewers that they can request access to the unaltered document 123 under specific conditions.

The document access manager 150 can also execute to manage access to the encrypted unaltered document 123 from recipients other than the user. In one implementation, document access manager 150 can implement a process to generate a new document access license 157 for an identified recipient. The new document access license 157 can thus come into creation after the altered document 121 is distributed. In an example of FIG. 1, the user input provided through the license interface 118 can identify the recipient for the new document access license 157, and the new document license 157 can be stored with, for example, the license store 154 for use with the document access manager 150. The document access manager 150 provide access to the unaltered document 123 based on a predetermined access protocol or process in which a non-licensed user can request access to the document and is then granted or denied access. In particular, document access manager 150 can implement a process in which requests 153 for access 159 to an unaltered document 123 are received (e.g., based on a recipient viewing the altered document 121). For example, the altered document 121 can be provided with a trigger 119 that is selectable by recipients to generate the access request 153 for the unaltered document 123. The trigger 119 can correspond to a link (e.g., uniform resource locator (URL)) or QR code. The trigger 119 can be activated by recipient selection input, such as link selection or programmatic reading of the QR code.

In one implementation, the document access manager 150 manages such requests, and further provides the user (owner of the unaltered document 123) the ability to add the requesting recipient to an access list 115 or queue from which a new document license 157 is generated and stored for use by the document access manager 150. When the request 153 is received, the document access manager 150 can signal a notification 155 to the license interface 118 of the user interface to prompt the user (e.g., document owner) into providing input for accepting (or denying the request). If the request is accepted, the new document license 157 is generated for the recipient and stored in the license store 154 for use with document access manager 150. The document access manager 150 can respond to the recipient requesting access to the document by authenticating the recipient, and then generating the new document access license for that recipient to enable the recipient to access the license store 154. The recipient can then view the entire document in its original, unaltered form.

By way of example, an image with an altered portion can be distributed on a social networking environment, and recipients can request to view the entire image through a link that is embedded or provided with the altered form of the image. The trigger can for example, correspond to a link that, when selected, sends a message to the user (and owner) of the image. Once a recipient makes a request to the user, the user can then add the user to the access list 115. In one implementation, a new document access license 157 can be generated for the user. The recipient of the altered version of the image can subsequently access the unaltered version of the same image by submitting a request to the document access manager 150 and having the document access manager 150 issue a new document license for the recipient.

According to an aspect, the document access manager 150 can include an authentication component to identify requesters for the unaltered document 123 before permitting access 159 to the unaltered document 123. In one implementation, the authentication component of the document access manager 150 is based on an identifier associated with a recipient account, and the recipient can provide authentication by inputting data that matches credentials stored with the recipient's account. As an addition or variation, the identifier is programmatically generated or communicated via a client application. For example, the recipient can operate a device that utilizes system 100, and the identifier of the recipient can be generated by the user interface 110 executing on the user end device. In one implementation, the document access manager 150 resides in whole or in part on the service, and utilizes the identifier provided by the client application in order to determine whether the requester for the unaltered document 123 is on the document's access list 115. In one implementation, the requester/recipient can operate on a shared platform, so as to utilize functionality provided with system 100. The functionality can include for example, a viewer component 128 which can generate an identifier 129 that authenticates the requester to the document access manager 150. Once the requester is authenticated, the document access manager 150 can utilize a shared key to decrypt the unaltered document 123 and provide access 159 to the unaltered document. Alternatively, the document access manager 150 can provide the shared key to the terminal of the requester.

In one implementation, document access manager 150 maps the identification received from the user interface 110 (operating as a client application) to a name or other identifier (e.g., email address) in order to authenticate the individual making the request. The mapping can confirm that the individual making the request is the same person or recipient as provided for in the access list 115 for the unaltered version of the document. Thus, individuals sharing of platform or client application can selectively share encrypted documents in unaltered form with one another simply by identifying each other through a service identifier.

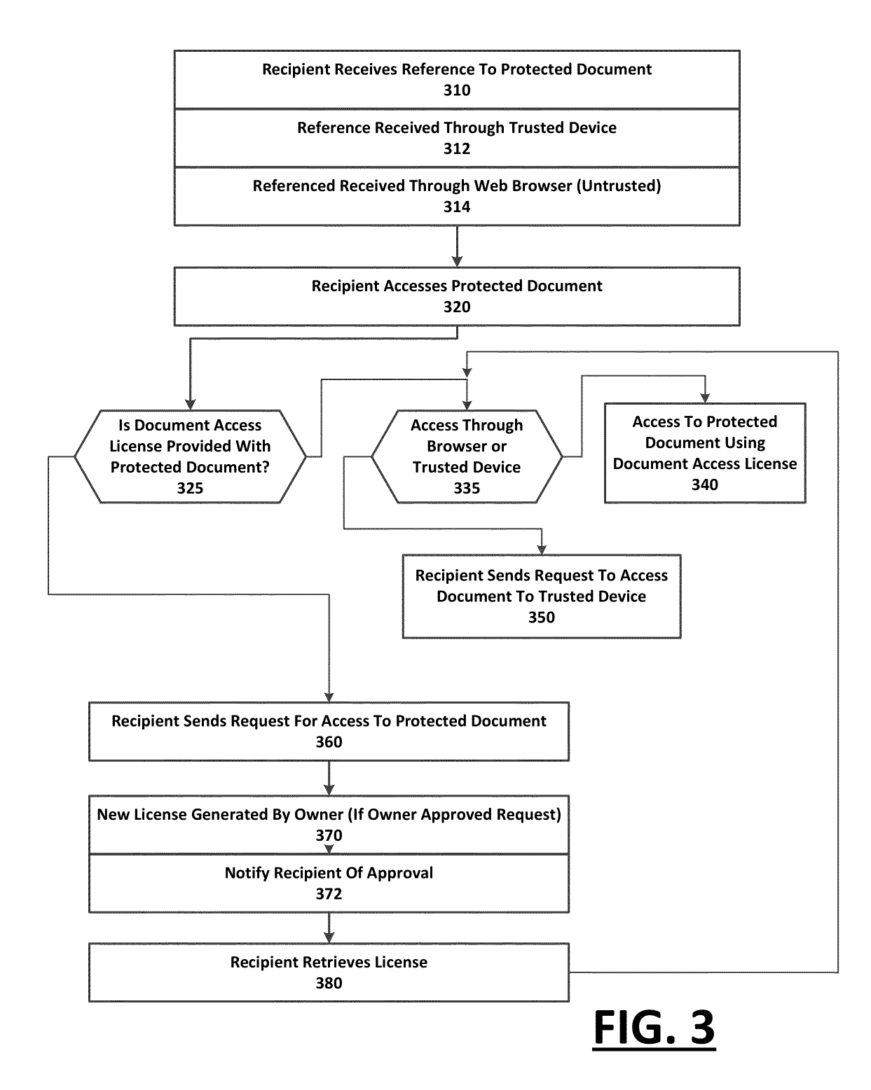

In variations, users can access the unaltered document 123 using a standard web browser. For example, a viewer of social networking content 152 can select to view the entire unaltered version of the document by clicking on the link provided with the altered document 121. The user's web browser can navigate the user to a website provided by system 100, where the user can identify themselves in order to view the unaltered version of the document 123. The user's identification can be provided by, for example, an email address or social networking identifier. For example, in one implementation, the recipient can request access to the unaltered document 123, and the system 100 may respond by requiring the user to provide authentication information such as an email address. The identifier the user provides, including the email address, can be communicated to the owner/user of the document. If the user grants the request, a communication may be provided to the email address of the requester that embeds an identifier for that requester, and the identifier can be added to the access list 115. Subsequently, the requester can access the document access manager 150 using the web browser, and provide information that allows for the requester to be authenticated through their respective email address. Once the requester is authenticated by email address or other identifier, the requester can be provided access to the unaltered document 123. In an example such provided by FIG. 3, the user can initiate a request for the unaltered document 123 through a browser, but ultimate access to the unaltered document is through the recipient's trusted device, which can correspond to a device (e.g., mobile computing device) on which a client application is provided to authenticate the recipient.

In one variation, submission interface 114 can implement encryption controls 133 regarding the manner in which a document is encrypted. The submission interface 114 can implement timing controls, controlling how long, for example, a shared key can be used by particular individuals or class of individuals in the access list 115 for a particular document. The timing controls can limit, for example, a particular recipient of the access list 115 to viewing the unaltered document 123 for set duration of time (e.g., three days).

Methodology

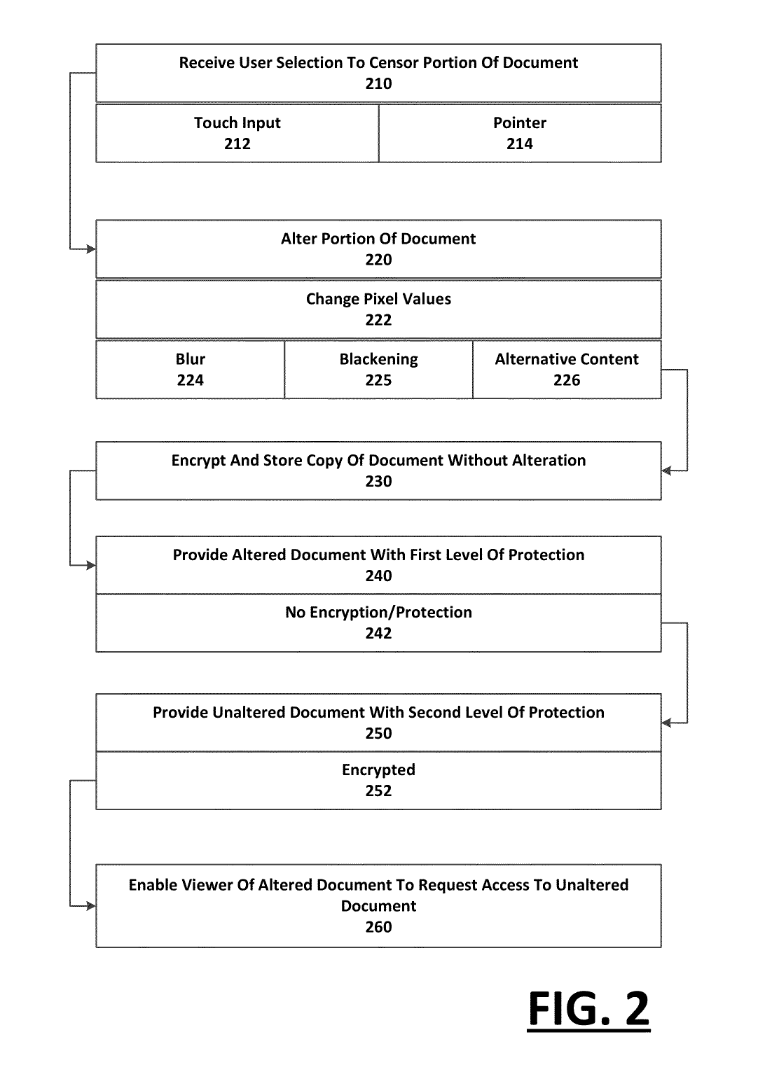

FIG. 2 implements a method for enabling selective sharing of censored documents, according to one or more embodiments. FIG. 3 illustrates a method for operating a recipient device to access a protected document, according to one or more embodiments. A method such as described with an example of FIG. 2 or FIG. 3 can be implemented using a system such as described with a system of FIG. 1. Accordingly, reference may be made to elements of system 100 for purpose of illustrating suitable components or elements for performing a step or sub-step being described.

With reference to an example of FIG. 2, a user selection is received to censor a portion of a document (210). In one implementation, the selection input corresponds to touch input (212). For example, the user can operate a computing device with a touch sensitive screen, and then use a finger or other object to touch portions of the document. In a variation, and other input mechanism such as a pointer can be utilized to identify portions of the document that are to be censored (214).

A region of the document corresponding to the portions identified in (212) is altered so as to be censored (220). The document can be censored by altering a region of the document that includes the identified portions. In one implementation, censoring can correspond to changing pixel values of the document in one or more select region corresponding to the portion identified by the user input (222). Accordingly, an embodiment provides that a portion of the document is censored so as to render content that is altered from its original form. For example, alteration component 130 can provide altered content for the select region of the document that corresponds to blurriness (224), blackening (225), or alternative content (226) in place of original content.

Additionally, an unaltered copy of the document can be encrypted and stored for subsequent access (230). For example, system 100 can store an encrypted form of the unaltered document 123 with the document data store 134.

According to some embodiments, the altered (or censored) document 123 can be provided with a first level of protection (240). The altered document 123 can be provided for a first group of recipients or audience. In one implementation, the group of users or audience can include, for example, a general public or a social network of the particular user. Additionally, a first level of protection can correspond to general distribution to a group or class of users without any additional document protection (e.g., anyone can view the document) (242). In variations, a limited and additional level protection can be provided to the censored or altered document 123. For example, the document can be password-protected or made available only to those individuals who have some form of permission to view the content of the user (e.g., such as recipients that are in the user social network).

The unaltered document can be provided with the second level of protection (250). The second level protection can correspond to a stronger form of document protection then what is made available for the censored version of the document. In one implementation, system 100 encrypts the unaltered document 123, so that the document is only accessible for those users who are identified in the Document Access License for that document (252).

In some variations, the viewer of the censored or altered document can make a request to view the unaltered and protected document (260). For example, alteration component 130 can embed a link or other programmatic trigger (e.g. QR code) that can be acted upon by the recipient in order to generate the request 153. The request 153 can be communicated as notification 155 to the user, who can then grant or deny access to the encrypted and unaltered document 123.

With reference to an example of FIG. 3, a recipient receives a reference to a protected document (310). The reference can be provided with, for example, an altered version of the document. The reference can be in the form of a Uniform Resource Locator (URL) or other active link. In one implementation, the recipient receives the reference on a trusted device, such as a device on which a client application operates to authenticate the user (312). As an alternative or variation, the recipient can receive the reference from an untrusted source, such as through a web browser (314). For example, the user can access the altered version of the document on a social networking site using a standard browser, then use a link embedded with the altered document to receive the reference.

The recipient accesses the protected document using the reference (320) on a recipient device (which can be either a trusted or untrusted device). For example, the user can select the link or URL provided with the altered document. For example, the user can retrieve the protected document in encrypted form.

In response to the recipient attempting to open the protected document, a determination is made as to whether a document access license is provided with the protected document for the recipient (325).

If the document access license is not provided with the protected document, the recipient can trigger a request from the recipient device (360). For example, the recipient device can trigger a message through a messaging interface of system 100. The message can be provided with identifiers to identify the owner of the document. The identifiers can be provided through metadata included with, for example, the protected document or the reference. The message can be communicated to the document owner, who can then elect to grant or deny the access.

When the document owner accepts the request, system 100 generates a new document access license for the recipient (370). System 100 can message or otherwise notify the recipient that access to the protected document was granted (372). If access is not granted, then the user cannot view the protected document, but may view the altered version of the document. The recipient can attempt to access the protected document again (380), in which case the method returns to (325).

If the determination in (325) is that the recipient can access the protected document, then another determination is made as to whether the access is being requested from a trusted device (335). If the request comes from the trusted device, then access to the document is provided based on the document access license for the recipient (340). If the request comes from an untrusted device (e.g., recipient operating a browser), then the recipient sends a request to the user's trusted device (350). For example, the user can send the self-request to the user's own mobile device. The recipient can then access the protected document on the trusted device.

### EXAMPLE

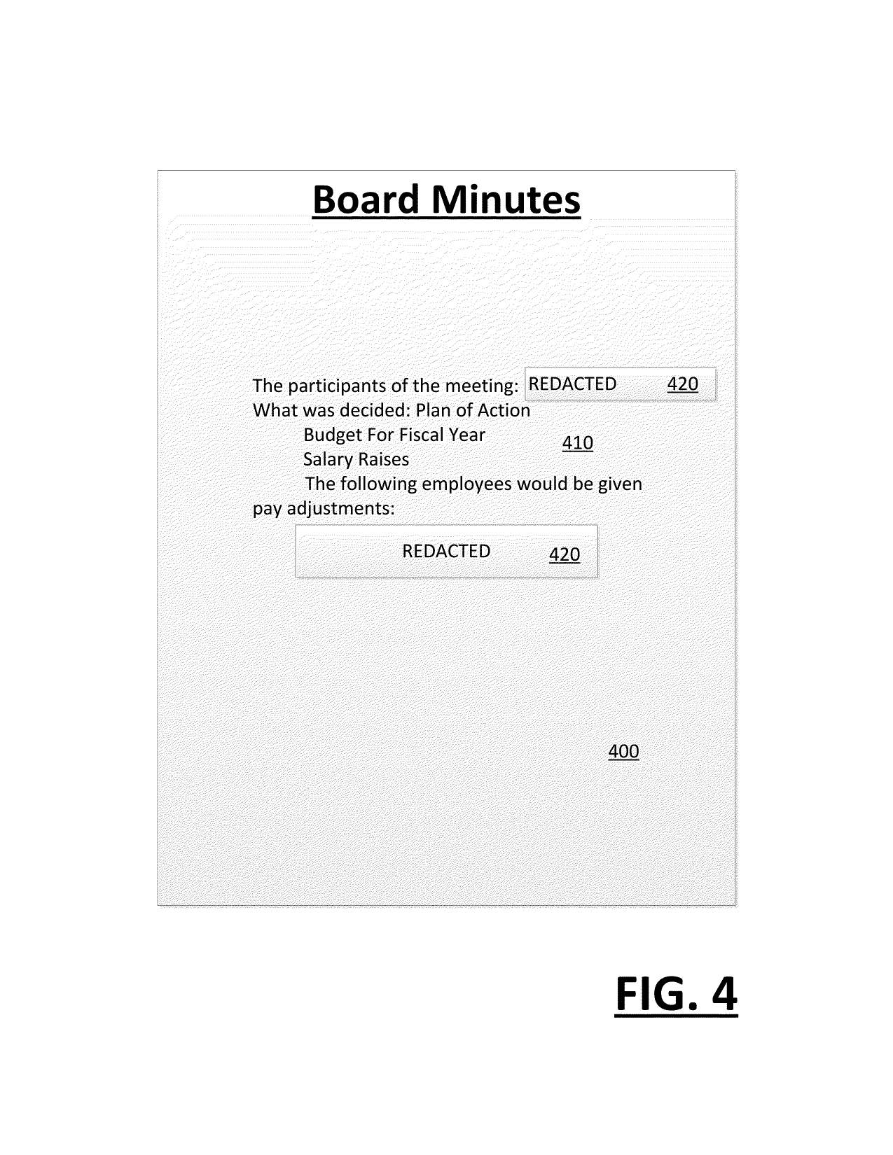

FIG. 4 illustrates an example implementation of a censored document, according to one or more embodiments. An example such as provided by FIG. 4 can be generated using a system such as described with an example of FIG. 1, and further using a method such as described by an example of FIG. 2 or FIG. 3.

In an example of FIG. 4, a censored document 400 can correspond to a PDF, JPEG or any other suitable document format. Content can be provided in the document. In this particular example, the content is in the form of text. In variations, the content can be the form of images. A user or owner of the document can specify input that identifies one or more regions of the document that are to be censored. The censored document permanently alters the pixel values of those regions that are selected for censoring, so that the original content cannot be discerned or otherwise viewed from data provided with the document. In the example provided, two regions of the document are censored, with pixels occupying those portions being altered in value. While some examples provide for the pixels of censored regions to become blurred or blackened, the particular example depicted by FIG. 4 incorporates alternative text content in place of the original content. The alternative text content includes word (e.g., “REDACTED”).

In one implementation, a viewer of the censored document 400 can request access to an uncensored but encrypted version of the document. For example, the user can activate a link or other programmatic elements provided with the censored document 400, then provide identification information in order to make the request for the uncensored version of the document. The owner of the document can determine to accept or deny the request. If accepted, an uncensored version of the document can be rendered for the user. According to one implementation, while the uncensored version is stored separately and provided to replace the censored document 400, display graphics and functionality can be utilized to blend in the uncensored document so as to appear that the previously censored regions are being revealed to the user.

The example of FIG. 4 provides for multiple censored regions. In one variation, multiple copies of the censored document can be maintained so that different classes of users can view different levels of censored documents. For example, with reference to FIG. 4, censored document 400 can include a partially censored and encrypted counterpart that displays the region 410 in its original form (corresponding to participants of the meeting), but the document includes censored region 420 (corresponding of those employees who are to be given pay adjustments). Accordingly, first class of users may be able to view the censored document 400 with the first region 410 revealed, while another class of users may only view the censored document with both regions 410, 420 being censored. Additionally, censored document 400 can include an uncensored but encrypted version of the document.

Computer System

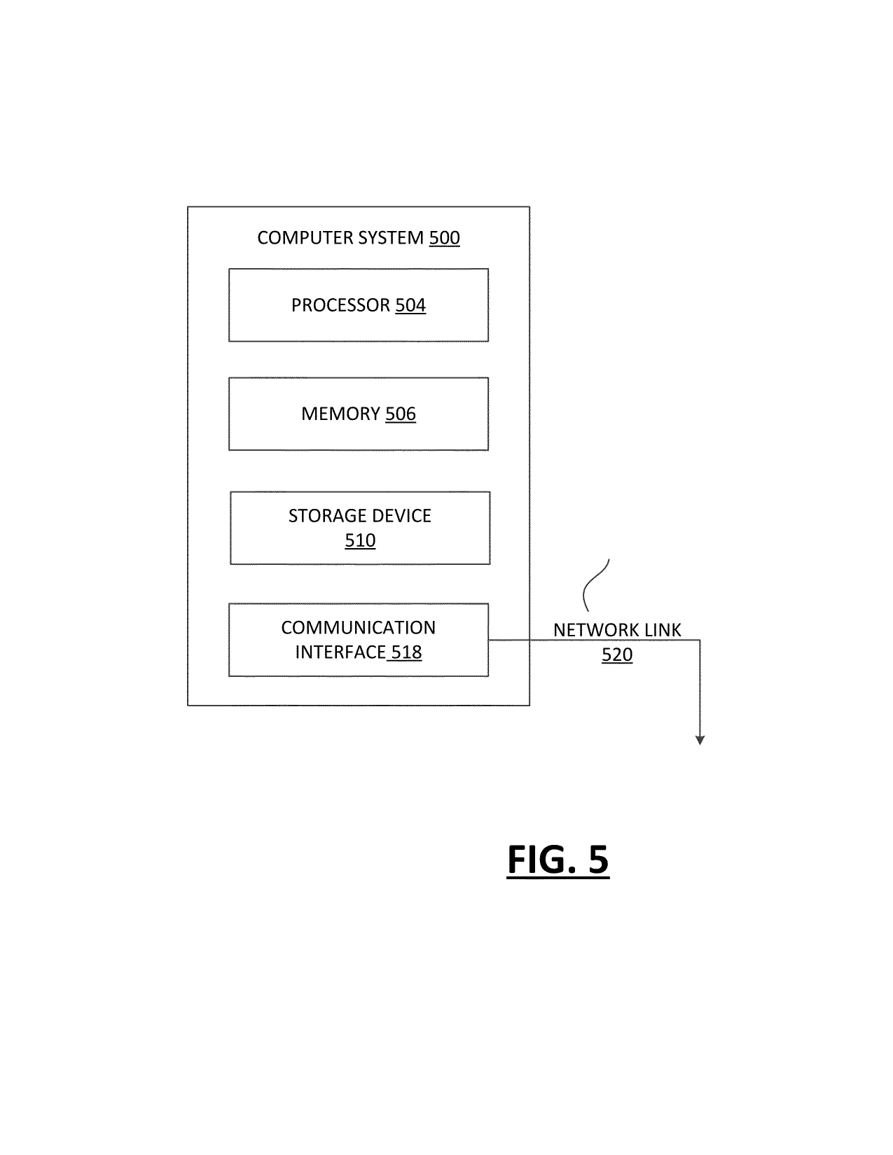

FIG. 5 is a block that illustrates a computer system upon which embodiments described herein may be implemented. For example, a system such as described with FIG. 1 can be implemented on a computer system such as described with an example of FIG. 1. Likewise, a method such as described with an example of FIG. 2 or FIG. 3 can also be implemented using a system such as described with FIG. 5.

In an embodiment, computer system 500 includes processor 504, memory 506 (including non-transitory memory), storage device 510, and communication interface 518. The memory 506 can include random access memory (RAM) or other dynamic storage resources, for storing information and instructions to be executed by processor 504. The memory 506 also may be used for storing temporary variables or other intermediate information during execution of instructions to be executed by processor 504. The memory 506 may also include a read only memory (ROM) or other static storage device for storing static information and instructions for processor 504. A storage device 510, such as a magnetic disk or optical disk, is provided for storing information and instructions. The communication interface 518 may enable the computer system 500 to communicate with one or more networks through use of the network link 520 (wireless or wireline).

In one implementation, memory 506 may store instructions for implementing functionality such as described with an example of FIG. 1, or implemented through an example method such as described with FIG. 2 or FIG. 3. Likewise, the processor 504 may execute the instructions in providing functionality as described with a system such as described with FIG. 1, or with methods such as described with FIG. 2 or FIG. 3.

Embodiments described herein are related to the use of computer system 500 for implementing the techniques described herein. According to one embodiment, those techniques are performed by computer system 500 in response to processor 504 executing one or more sequences of one or more instructions contained in memory 506. Such instructions may be read into memory 506 from another machine-readable medium, such as storage device 510. Execution of the sequences of instructions contained in memory 506 causes processor 504 to perform the process steps described herein. In alternative embodiments, hard-wired circuitry may be used in place of or in combination with software instructions to implement embodiments described herein. Thus, embodiments described are not limited to any specific combination of hardware circuitry and software.

Although illustrative embodiments have been described in detail herein with reference to the accompanying drawings, variations to specific embodiments and details are encompassed by this disclosure. It is intended that the scope of embodiments described herein be defined by claims and their equivalents. Furthermore, it is contemplated that a particular feature described, either individually or as part of an embodiment, can be combined with other individually described features, or parts of other embodiments. Thus, absence of describing combinations should not preclude the inventor(s) from claiming rights to such combinations.

What is claimed is:

1. A method for securely sharing information, the method being implemented by one or more processors and comprising:
altering a portion of a document in response to a user selection input to protect that portion, so that only the portion of the document is viewable as compared to when the portion of the document is unaltered;
storing a copy of the document with the portion unaltered;
identifying one or more recipients that are permitted to view the document in its entirety; and
providing the copy of the document with the portion unaltered to the one or more recipients.

2. The method of claim 1, wherein the document corresponds to an image file, and wherein the method further comprises:
detecting input corresponding to the user touching a display screen on which the image is displayed in order to identify the portion of the image that is to be altered.

3. The method of claim 2, wherein altering the portion includes pixelating the portion of the image corresponding to where the user contacted the display screen.

4. The method of claim 3, wherein pixelating the portion of the image includes permanently altering pixel values corresponding to the portion of the image so that the portion cannot be re-created using only the image with the altered portion.

5. The method of claim 1, further comprising storing the copy of the document in encrypted form, and wherein providing the copy of the document includes enabling access to the document using a distributed key.

6. The method of claim 1, further comprising:
enabling distribution of the document with the portion altered to a first set of recipients.

7. The method of claim 6, further comprising:
enabling individual recipients in the first set of recipients to request access to the document with the portion unaltered.

8. The method of claim 6, wherein enabling distribution of the document includes enabling the document to be published in a social network environment with the portion altered, and wherein the method further comprises:
receiving requests from 1 or more recipients of access the document with the portion unaltered; and
selectively communicating the copy of the document to individual recipients who requested access.

9. A non-transitory computer-readable medium that stores instructions for operating a computing device, the instructions being executable by one or more processors to perform operations that include:
altering a portion of a document in response to a user selection input to protect that portion, so that only the portion of the document is viewable as compared to when the portion of the document is unaltered;
storing a copy of the document with the portion unaltered;
identifying one or more recipients that are permitted to view the document in its entirety; and
providing the copy of the document with the portion unaltered to the one or more recipients.

10. The computer-readable medium of claim 9, wherein the document corresponds to an image file, and further comprising instructions for:
detecting input corresponding to the user touching a display screen on which the image is displayed in order to identify the portion of the image that is to be altered.

11. The computer-readable medium of claim 10, wherein altering the portion includes pixelating the portion of the image corresponding to where the user contacted the display screen.

12. The computer-readable medium of claim 11, wherein pixelating the portion of the image includes permanently altering pixel values corresponding to the portion of the image so that the portion cannot be re-created using only the image with the altered portion.

13. The computer-readable medium of claim 9, further comprising instructions for storing the copy of the document in encrypted form, and wherein providing the copy of the document includes enabling access to the document using a distributed key.

14. The computer-readable medium of claim 9, further comprising instructions for:
enabling distribution of the document with the portion altered to a first set of recipients.

15. The computer-readable medium of claim 14, further comprising instructions for:
enabling individual recipients in the first set of recipients to request access to the document with the portion unaltered.

16. The computer-readable medium of claim 14, wherein enabling distribution of the document includes enabling the document to be published in a social network environment with the portion altered, and further comprising instructions for:
receiving requests from 1 or more recipients of access the document with the portion unaltered; and
selectively communicating the copy of the document to individual recipients who requested access.

17. A computer system comprising:
a memory that stores a set of instructions;
a display screen; and
one or more processors that use instructions from the memory to:
alter a portion of a document in response to a user selection input to protect that portion, so that only the portion of the document is viewable as compared to when the portion of the document is unaltered;
store a copy of the document with the portion unaltered;
identify one or more recipients that are permitted to view the document in its entirety; and
provide the copy of the document with the portion unaltered to the one or more recipients.

18. The system of claim 17, wherein the document corresponds to an image file, and wherein the one or more processors further use instructions from the memory to:
detect input corresponding to the user touching the display screen on which the image is displayed in order to identify the portion of the image that is to be altered.

19. The system of claim 18, wherein altering the portion includes pixelating the portion of the image corresponding to where the user contacted the display screen.

20. The system of claim 19, wherein pixelating the portion of the image includes permanently altering pixel values corresponding to the portion of the image so that the portion cannot be re-created using only the image with the altered portion.
